(19) United States
(12) Patent Application Publication
(10) Pub. No.: US 2016/0180365 A1
(43) Pub. Date: Jun. 23, 2016

(54) Instant Multimedia-Based Customer Feedback System

(71) Applicants: Jiazheng Shi, Campbell, CA (US); BOOGOO INTELLECTUAL PROPERTY LLC, Burlingame, CA (US)

(72) Inventor: Jiazheng Shi, Campbell, CA (US)

(73) Assignees: BOOGOO INTELLECTUAL PROPERTY LLC, Burlingame, CA (US); Jiazheng Shi, Campbell, CA (US)

(21) Appl. No.: 14/574,403

(22) Filed: Dec. 18, 2014

(51) Int. Cl. G06Q 30/02

(52) U.S. Cl. CPC G06Q 30/0217

(57) ABSTRACT

A multimedia-based online customer feedback system is described. The system provides the tools for a business to initiate invitations for multimedia-based feedbacks (e.g., video, photo, audio, text) from its existing or prospective customers. The business can also specify rewards for such feedbacks. A targeted customer can create his/her feedback regarding the business in video, photo, audio, and/or text (by using his/her smart phone, for example) and submit his/her feedback to the system. The system then prescreens the feedback to make sure it is relevant to the business and notifies the business of the feedback. If there is a reward specified by the business, the system imposes digital protection on the feedback and removes the protection only after the business has fulfilled the reward.

### FIELD OF INVENTION

This invention relates to a system for instantly harvesting, processing, and displaying multimedia-based customer feedback information.

### BACKGROUND OF THE INVENTION

Using online customer feedback information (e.g., testimonial, review comment, or survey on a product or service) can be a powerful way of improving product or service, promoting and advertising business, engaging customers, and building strong customer relationship. Currently, there are online systems available for providing text-oriented feedbacks. For example, Angie's List™ allows paid members to search and review businesses on its website. There are some systems that support photo attachments. For example, eBay™ allows buyers to leave feedbacks to businesses with photo attachments. Most review systems, such as Yelp™ and Google Place™, are customer-driven. Business owners have minimal involvement in users' feedbacks. Miscommunications or lack of communication between businesses and customers can often lead to misunderstanding between the parties and even negative customer feedbacks. Furthermore, these systems lack efficient tools for resolving customer related issues. As such, businesses are not necessarily benefited for their growth.

Another drawback of the current customer feedback systems is that these systems rely heavily on text-based feedbacks. It is difficult and time consuming for users to compose text-based feedbacks. Similarly, it is also difficult and time consuming for prospective customers to read through and digest these feedbacks. As a result, users are frequently discouraged from submitting such feedbacks and prospective customers more often just resort to the number of stars (i.e., ratings) to make up their mind. Furthermore, text based feedbacks are prone to reviewers' biases, emotions, and subjective beliefs. In contrast, videos or photos are more objective and can provide multi-dimensional information desired by prospective customers.

Yet another drawback of the current customer feedback systems is that users are not encouraged to provide instant, on-the-spot feedbacks and tend to wait until later, sometimes days or even weeks, to provide their feedbacks. Customers tend to provide more relevant, focused, and honest feedbacks when they are experiencing or just experienced the services at issue than after waiting for a long period of time, during which their memories could fade. Furthermore, providing instant, on-the-spot feedbacks helps to resolve issues between customers and businesses quickly.

Thus, there is a need for an instant, on the spot, multimedia-based online customer feedback system with better response rate.

### SUMMARY OF THE INVENTION

In one embodiment of the present invention, a multimedia-based online customer feedback system is described. The system provides the tools for a business to initiate invitations for multimedia-based feedbacks (e.g., video, photo, audio, text) from its existing or prospective customers. Upon receiving such an initiation request, the system generates the invitations as emails, Short Message Service (“SMS”) messages, and/or messages/notices in other data formats, and sends them via wired or wireless networks to the targeted customers. After receiving such an invitation, a targeted customer can create his/her feedback of the business in video, photo, audio, and/or text (by using his/her smart phone, for example) and submit his/her feedback for publishing on social media or the business' webpage. Alternatively, a customer may submit feedback to a business without such a specific invitation. For example, a website of the business may have a button or a link directing a customer who is browsing the website to a particular webpage, through which the customer can submit his/her feedback. Or, the business has a flyer or poster with a printed QR/bar code. Upon scanning the QR/bar code with a smart phone, the customer is prompted with a dialog box or application page, through which the customer can submit his/her feedback.

In a second embodiment of the present invention, the multimedia-based online customer feedback system provides the tools for a business to specify rewards in exchange for high quality multimedia-based feedbacks or testimonials. The reward can be a one-time monetary prize such as a coupon, credit, etc. or an on-going profit sharing plan to be applied to all or part of the future profits attributable to the customer's feedback or testimonial. The reward can be honored after feedback acceptance or submission, or even before submission to encourage customers. The feedback system also includes an escrow mechanism to implement and facilitate any reward transaction between the business and the customer whose feedback or testimonial is selected and used by the business.

In a third embodiment of the present invention, the multimedia-based online customer feedback system is integrated with a payment system, such as a Point of Sale (“POS”) system, an electronic wallet application, a scan and pay system, or a reward system, to support instant, on-the-spot customer feedbacks by customers.

In a fourth embodiment of the present invention, the multimedia-based online customer feedback system can atomically characterize a feedback and decide the relevancy of the feedback to the business at issue. Furthermore, the system allows a business to initially tag relevant feedbacks and then adaptively learns the business's expectation so that it can more accurately weed out irrelevant feedbacks, saving the business from spending a lot of time on evaluating voluminous feedbacks.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the leftmost digit of a reference number identifies the drawing in which the reference number first appears.

FIG. 1 is a system diagram illustrating the multimedia-based online customer feedback system;

FIG. 2 is a flow diagram illustrating a process of initiating a customer feedback campaign on the multimedia-based online customer feedback system;

FIG. 3 is a flow diagram illustrating a process of receiving and storing a multimedia-based feedback from a customer on the multimedia-based online customer feedback system;

FIG. 4 is a flow diagram illustrating a process of releasing a customer feedback for publishing.

FIG. 5 is a flow diagram illustrating an instant, on-the-spot customer feedback process provided by the multimedia-based online customer feedback system; and

FIG. 6 is a graphic user interface which allows a user to create a multimedia-based feedback of a business and submit the feedback from a mobile device.

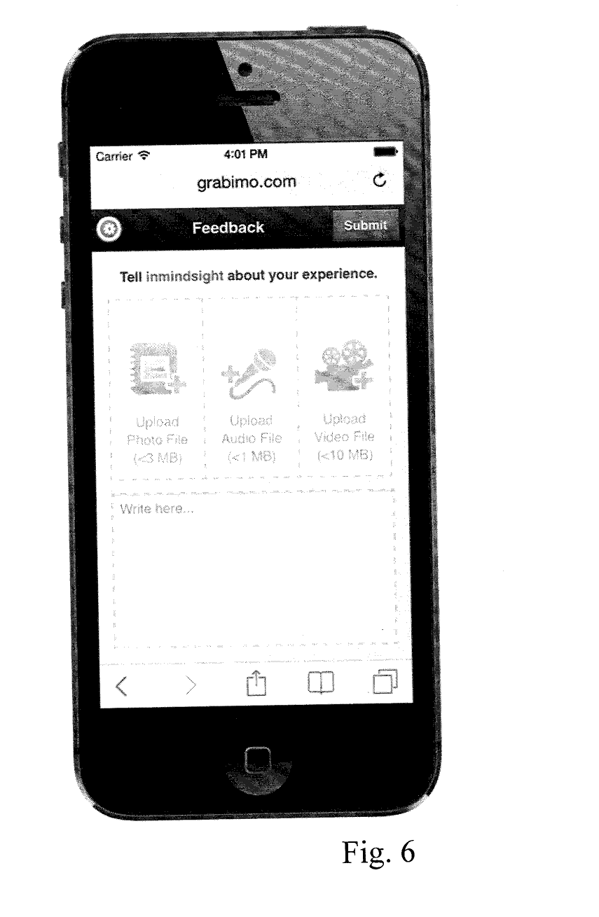

### DETAILED DESCRIPTION

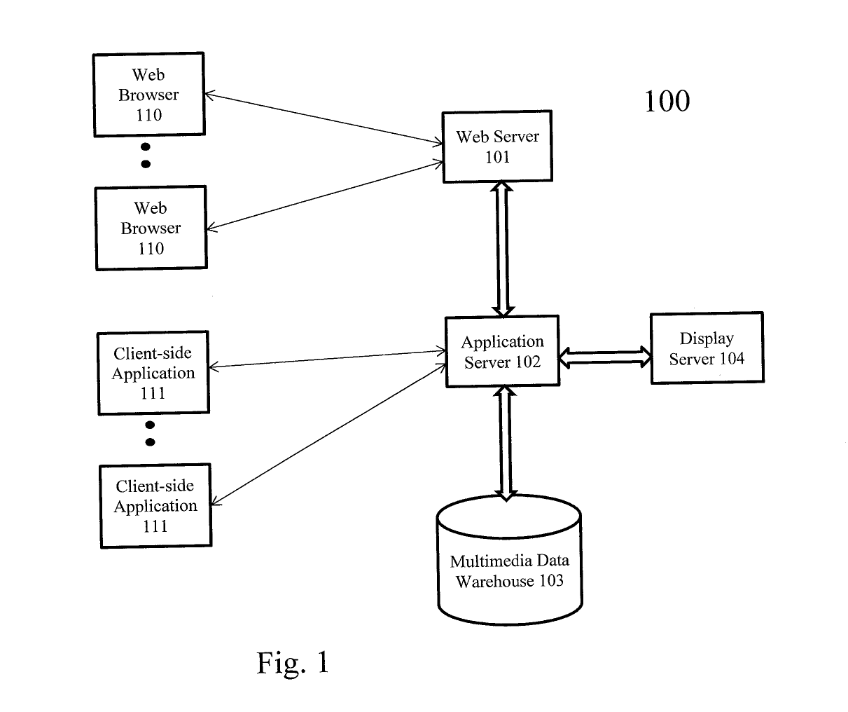

FIG. 1 illustrates a multimedia-based online customer feedback system (100) (hereinafter, the “System”). In one embodiment, the System (100) includes a web server (101), an application server (102), a multimedia data warehouse (103), and a display server (104). The web server (101) communicates with one or more web browsers (110) operating on mobile devices (e.g., smart phones) and/or workstations (e.g., personal computers) via wired and/or wireless networks (e.g., the Internet). For example, a business owner can initiate a customer feedback campaign from one of these web browsers (110). As another example, a customer can submit multimedia content as part of his/her feedback from a browser (110). Upon receiving the information, the web server (101) communicates the information to the application server (102) which processes the information according to the current operation. For example, if the current operation is starting a customer feedback campaign for a business, the application server (102) generates invitations in emails, SMS, or other types of electronic messages based on the information received from the web server (101) and then distributes these invitations to targeted customers. If the current operation is processing a multimedia-based feedback from a customer, the application server (102) processes the multimedia content (e.g., video, audio, photo, text) received from the web server (101) and stores the content in the multimedia data warehouse (103). It should be noted that the communications between the web server (101) and the web browsers (110) and the communications between the web server (101) and the application server (102) are both two-way communications. For example, after a business owner started a customer feedback campaign, he/she can check the feedbacks already provided by customers and decide which feedbacks he/she would like to publish on the business' company website or social media site, television, or any media display device. In this scenario, the application server (102) retrieves the available feedbacks and sends them to the browser (110) or any display device being used by the business owner. The business owner then selects the feedbacks he/she decides to use and communicate this information to the application server (102). The application server (102) then forwards the information to the display server (104), which processes the selected feedback(s) and posts them on the business' company website or social media site, as specified by the business owner.

In another embodiment, the application server (102) can also directly communicate with a client-side application (111) that is not a web browser, instead of going through the web server (101). For example, such a client-side application can be a smartphone application (e.g., iPhone App). Thus, customers or business owners can use these client-side applications (111) to achieve the same result. In this case, the client-side applications (111) need to be particularly downloaded and installed on the mobile devices and/or workstations.

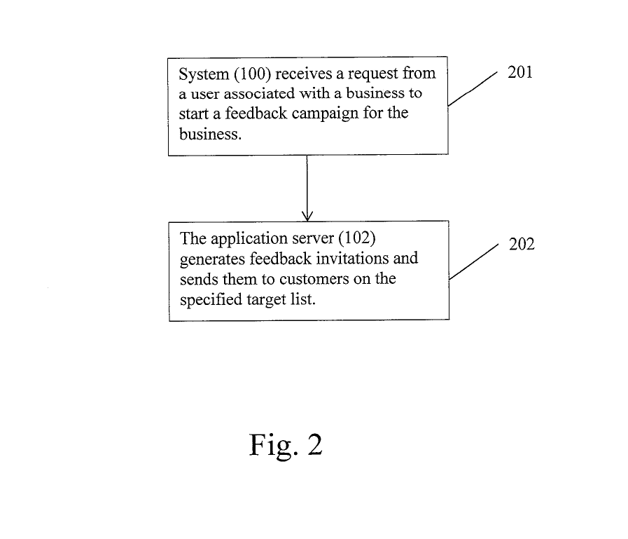

FIG. 2 shows a flow diagram of a process of initiating a customer feedback campaign on the System (100). At step 201, the System (100) receives a request from a user associated with a business to start a feedback campaign for the business. In one embodiment, the System (100) maintains a list of customers for the business. This list may include both existing and prospective customers accumulated in the past. Alternatively, the user can provide such a list to the System (100) or additional targets to be used in combination with the ones already existing in System (100). To avoid sending duplicated invitations to the same customer, System (100) can automatically filter out the duplicated email addresses or phone numbers. It can also provide advanced filtering options for the user. For example, the user may decide to limit the feedback campaign to customers who are located in San Francisco, electrical engineers, and/or interested in rock climbing. In another embodiment, the user can set a reward for the feedback campaign. For example, the reward can be a one-time payment for a video-based feedback accepted by the business, an on-going royalty payment depending on how many times the feedback is being clicked or viewed online, or a profit sharing plan based on the amount of revenue driven by the feedback. Furthermore, the user can specify a time limit for the campaign or leave the campaign open until the business decides to close it in the future.

At step 202, the application server (102) generates feedback invitations and sends them to customers on the specified target list. In one embodiment, the invitation is included in an email or SMS message that contains a URL link. By clicking on the URL link, a customer is directed to a webpage where he/she can learn details about the feedback campaign and upload multimedia content as his/her feedback. For customers who use client-side applications (111), the invitations can be implemented as push messages for the applications. A customer can open such a push message in the application (111) to view the relevant campaign information and upload his/her multimedia-based feedback of the business.

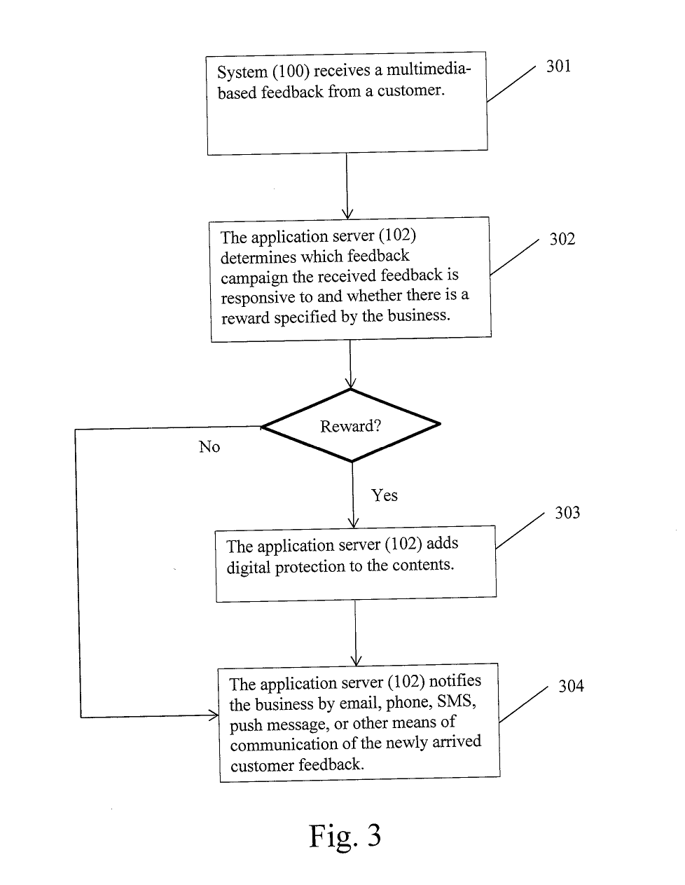

FIG. 3 shows a flow diagram of a process of receiving and storing a multimedia-based feedback from a customer on the System (100). After receiving an invitation for reviewing a business, a customer can follow the directions in the invitation to upload multimedia content as part of his/her feedback of the business. Depending on the device the customer is using, the invitation can even facilitate the customer to capture such multimedia content. For example, most smart phones have the capability of recording videos and audios. The invitation can direct the customer to a webpage displayed in a web browser on his/her smart phone where he/she can click a button, icon, or link to trigger the camera application. After capturing the content, the customer can upload the content through the web page as part or all of his/her feedback. Alternatively, a customer may submit feedback to a business without such a specific invitation. For example, a website of the business may have a button or a link directing a customer who is browsing the website to a particular webpage, through which the customer can submit his/her feedback. Or, the business has a flyer or poster with a printed QR/bar code. Upon scanning the QR/bar code with a smart phone, the customer is prompted with a dialog box or application page, through which the customer can submit his/her feedback.

In one embodiment, at step 301, the System (100) receives a multimedia-based feedback from a customer. In one embodiment, a feedback can contain multiple types of media contents (e.g., video, audio, photo, text). The application server (102) can receive all contents in one batch or in several batches from the customer. Once the application server (102) receives the full feedback, it will categorize the contents, preprocess them (e.g., downsizing, format normalization), and store them in the multimedia data warehouse (103).

At step 302, the application server (102) determines which feedback campaign the received feedback is responsive to and whether there is a reward specified by the business.

In addition, the application server (102) may use a content matching algorithm to prescreen the feedback before storing it into the multimedia data warehouse (103) at steps 301-302. This additional process can help to make sure that the received feedback is relevant to the business's service or product. For example, the content matching algorithm can help to determine whether the video or photo information in the feedback contains relevant elements of the business. For instance, relevant elements of a restaurant business may include plate, fork, cup, etc.; relevant elements of a landscape business may include tree, pool, flower, etc.; relevant elements of a fashion design business may include watch, clothes, model, etc. A relevancy score can be calculated based on the above process. If the score passes a preselected threshold, the application server (102) will store the feedback into the multimedia data warehouse (103) and proceed with the steps below.

If the application server (102) determines at step 302 that there is a reward, then the process goes to step 303, where the application server (102) adds digital protection to the contents. One example of such protection is adding watermarks to photos or videos. The watermarks can be visible symbols, such as consumer names imposed on pictures and video. Watermarks can be blocks that hide or make it difficult to view the visional content. Watermarks on audio can be noise or irregular interruption that makes it difficult to interpret the audio content. Another protection is blocking certain sentences or words of the text. The goal is to prevent the business from using the feedback and its content without fulfilling the reward to the reviewer first.

At step 304, the application server (102) notifies the business by email, phone, SMS, push message, or other means of communication of the newly arrived customer feedback.

Referring back to step 302, if there is no reward, the process skips step 303 and directly goes to step 304.

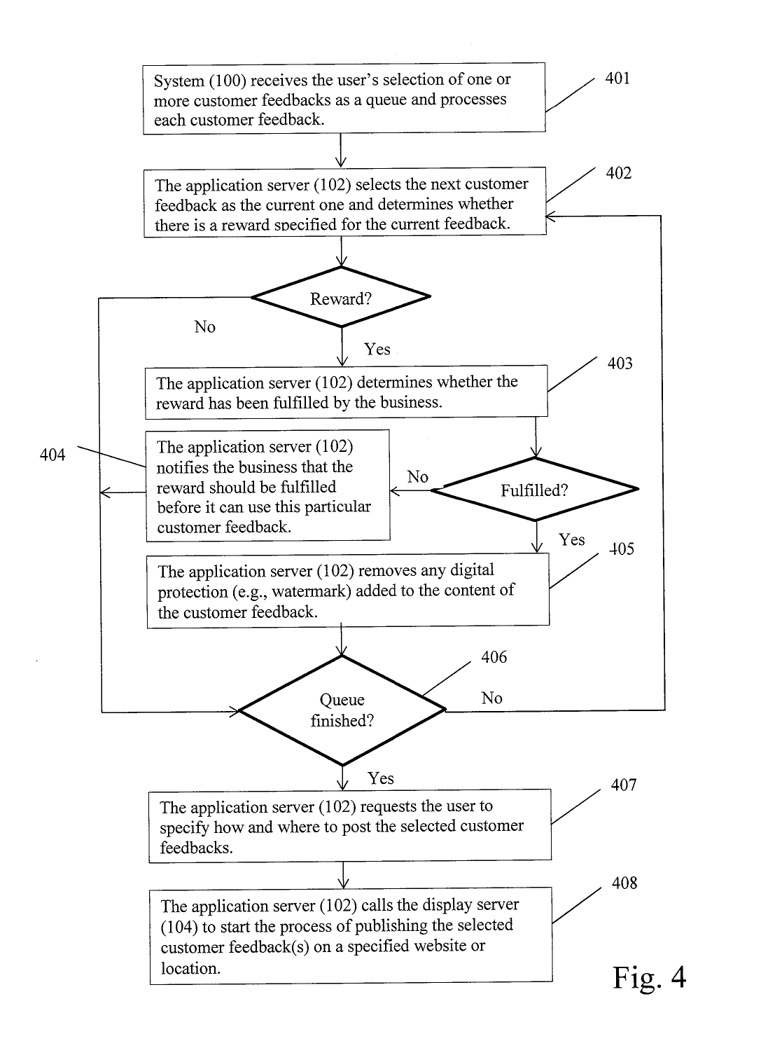

FIG. 4 shows a flow diagram of a process of releasing a customer feedback for publishing on the System (100). After the System (100) notifies a business of the arrived customer feedback(s), a user associated with the business can review the customer feedbacks online via a web browser (110) or a client-side application (111). The user can select the customer feedback(s) he/she wants to use for business promotion or advertisement. If a reward was specified, the user can use online tools to fulfill the reward. For example, if the reward is a one-time payment for the customer feedback, the user can make the payment by using credit card or other online payment tools such as PayPal™.

At step 401, the System (100) receives the user's selection of one or more customer feedbacks as a queue and processes each customer feedback as follows.

At step 402, the application server (102) determines whether there is a reward specified for the current customer feedback. If so, the process goes to step 403, where the application server (102) determines whether the reward has been fulfilled by the business. If there is no specified reward, the process goes to step 405.

At step 403, the application server (102) determines whether the reward has been fulfilled by the business. If not, the application server (102) notifies the business, at step 404, that the reward should be fulfilled before it can use this particular customer feedback and goes to step 406. Alternatively, the notification can be done after the application server (102) has finished processing all customer feedbacks in the queue. If the reward has already been fulfilled, the process goes to step 405, where the application server (102) removes any digital protection (e.g., watermark) added to the content of the customer feedback. Afterwards, the process goes to step 406.

At step 406, the application server (102) determines whether it has finished processing all customer feedbacks in the queue. If not, the process goes back to step 402 to process the next customer feedback in the queue. If yes, the process goes to step 407.

At step 407, the application server (102) requests the user to specify how and where to post the selected customer feedbacks. In one embodiment, the System (100) already has such information as part of the profile of the business maintained in a relational database or a NoSQL database (not shown in FIG. 1.)

At step 408, the application server (102) calls the display server (104) to start the process of publishing the selected customer feedback(s) on a specified website or location, such as a “media wall.” A media wall is a standalone display that can be easily integrated with other systems of a business. For example, the display may have an iframe plugin component connected to the business's company website. The content displayed on the media wall and its style can be customized and adjusted by a user.

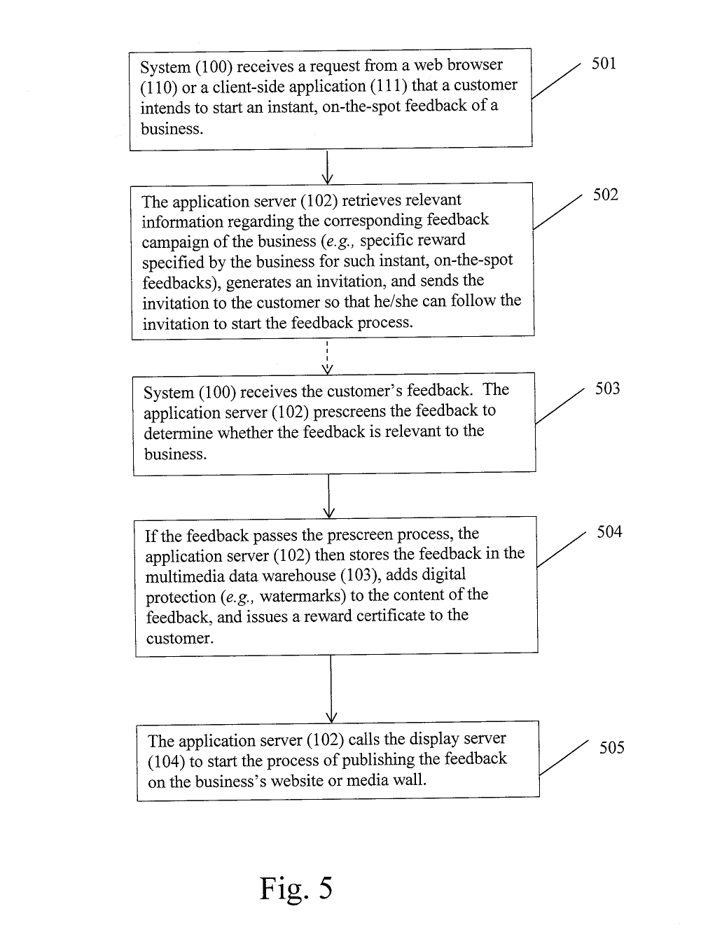

FIG. 5 shows a flow diagram of an instant, on-the-spot customer feedback process on the System (100). In one embodiment, a customer can scan a QR code or bar code or detect a Near Field Communication (“NFC”) signal at a location of a business to start his/her feedback of the business. The customer can take a photo, record video, and/or write up a comment to compose a multimedia-based feedback and then submits his/her feedback before leaving the venue of the business. The business receives the customer's feedback instantly and can either give the customer a discount, credit, or coupon as reward.

At step 501, the System (100) receives a request from a web browser (110) or a client-side application (111) that a customer intends to start an instant, on-the-spot feedback of a business. This may be triggered, for example, by the customer using a smartphone to scan a QR code or bar code or detect an NFC signal at the venue of the business. Alternatively, the business may have a message pushing service operating at the venue. The message pushing service can detect a mobile device (e.g., smartphone) if it is within a certain distance (e.g., within the boundary of the venue) or using the WIFI service of the business. The message pushing service then pushes a message to the mobile device. The user of the mobile device can accept the message to send a request to the System (100).

At step 502, the application server (102) retrieves relevant information regarding the corresponding feedback campaign of the business (e.g., specific reward specified by the business for such instant, on-the-spot feedbacks), generates an invitation, and sends the invitation to the customer so that he/she can follow the invitation to start the feedback process. In addition, the application server (102) can specify a time limit (e.g., half hour, an hour) within which the customer must respond to the invitation and submit his/her feedback.

In another embodiment, a mobile device has a client-side application (111) installed on it. The client-side application (111) can detect the location of the mobile device and determine whether it is on the venue of a business. If so and if the business accepts instant, on-the-spot feedbacks, the client-side application (111) displays an invitation to inform the user. The user can follow the instruction of the invitation to start the process.

Yet in another embodiment, steps 501 and 502 can be skipped. For example, a customer can submit his/her feedback by all of the above discussed options (e.g., scanning a QR code or bar code, detecting an NFC signal at the venue of the business, receiving a client-side invitation based on the customer's location) without the System (100)'s involvement (e.g., sending an invitation). In this case, an identification of the business or any unique number associated with the business should also be sent to the System (100) so that it can determine to which business the feedback pertains.

At step 503, the System (100) receives the customer's feedback. The application server (102) prescreens the feedback to determine whether the feedback is relevant to the business by using the process described above with respect to FIG. 3.

If the feedback passes the prescreen process, the application server (102) then stores the feedback in the multimedia data warehouse (103), adds digital protection (e.g., watermarks) to the content of the feedback, and issues a reward certificate to the customer at step 504. The reward certificate can be represented by a QR code, bar code, or any other type of code that can be displayed on the customer's mobile phone and redeemed during checkout.

Alternatively, the reward certificate is not issued until the business has reviewed and selected the feedback from the customer. In this case, the application server (102) notifies the business by email, phone, SMS, push message, or other means of communication of the newly arrived customer feedback. Only if the application server (102) receives a confirmation from the business that it has reviewed and selected the feedback would the application server (102) send the reward certificate to the customer and remove any digital protection imposed on the content of the feedback.

At step 505, the application server (102) calls the display server (104) to start the process of publishing the feedback on the business's website or media wall, as discussed previously.

In one embodiment, a checkout system of the business (e.g., a Point of Sale (“POS”) system, an electronic wallet application, a scan and pay system) is integrated with or connected to the System (100). As such, the application server (102) can directly send the reward information to the checkout system so that the reward (e.g., a discount, credit) is automatically applied to the final bill to the customer.

We claim:

1. A method comprising:
receiving from a client-side application a multimedia-based feedback, wherein the multimedia-based feedback contains at least a photo portion or a video portion and is responsive to a feedback campaign of a business entity;
determining whether the multimedia-based feedback is relevant to the business entity;
issuing a reward certificate and sending the reward certificate to the client-side application; and
sending the multimedia-based feedback to a domain space associated with the business entity for publication.

2. The method of claim 1 further comprising the following steps before said receiving from a client-side application a multimedia-based feedback:
receiving from the client-side application a message indicating a user is at a venue of the business entity and intends to provide the multimedia-based feedback;
retrieving information regarding the feedback campaign of the business entity; and
sending an invitation for providing the multimedia-based feedback to the client-side application.

3. The method of claim 2, wherein the message includes information regarding a unique code associated with said feedback campaign of the business entity.

4. The method of claim 3, wherein the unique code is a QR code or a bar code.

5. The method of claim 2, wherein said invitation includes information regarding a reward associated with the feedback campaign of the business entity.

6. The method of claim 1, wherein said determining whether the multimedia-based feedback is relevant to the business entity comprises calculating a relevancy score based on whether the photo portion or video portion contains one or more elements from a set of elements relevant to the business entity.

7. The method of claim 6, wherein said set of elements include a plate element if the business entity is a restaurant.

8. The method of claim 1 further comprising the following steps after said determining step and before said issuing step:
imposing digital protection on the multimedia-based feedback;
notifying the business of the multimedia-based feedback;
receiving a confirmation from the business that it has accepted this multimedia-based feedback; and
removing the digital protection from the multimedia-based feedback.

9. The method of claim 8, wherein said digital protection is a watermark.

10. The method of claim 1, wherein said client-side application is a web browser.

11. A method comprising:
receiving from a client-side application a multimedia-based feedback, wherein the multimedia-based feedback contains at least a photo portion or a video portion and is responsive to a feedback campaign of a business entity;
imposing digital protection on the multimedia-based feedback;
notifying the business of the multimedia-based feedback;
receiving a confirmation from the business that it has accepted this multimedia-based feedback; and
removing the digital protection from the multimedia-based feedback;
sending a reward certificate to the client-side application; and
sending the multimedia-based feedback to a domain space associated with the business entity for publication.

12. The method of claim 11 further comprising determining whether the multimedia-based feedback is relevant to the business entity before said imposing step.

13. The method of claim 11, wherein said determining whether the multimedia-based feedback is relevant to the business entity comprises calculating a relevancy score based on whether the photo portion or video portion contains one or more elements from a set of elements relevant to the business entity.

14. The method of claim 13, wherein said set of elements include one of a plate, a fork, and a cup if the business entity is a restaurant.

15. The method of claim 13, wherein said set of elements include one of a tree, a pool, and a flower if the business entity is a landscape business.

16. The method of claim 11, wherein said digital protection is a watermark.

17. The method of claim 16, wherein said client-side application is a web browser.
